(19) United States
(12) Patent Application Publication
(10) Pub. No.: US 2025/0262824 A1
(43) Pub. Date: Aug. 21, 2025

(54) CONNECTOR GRIDS AND METHODS OF USING THE SAME TO ADDITIVELY MANUFACTURE PARTS

(71) Applicant: Carbon, Inc., Redwood City, CA (US)

(72) Inventors: Stephen J. Peter, San Francisco, CA (US); Michael Murillo, Menlo Park, CA (US); Elliott Steele Baker, San Mateo, CA (US); Alexander D. Denmark, Redwood City, CA (US); Owen Lu, San Mateo, CA (US)

(21) Appl. No.: 19/059,927

(22) Filed: Feb. 21, 2025

Related U.S. Application Data
(60) Provisional application No. 63/556,208, filed on Feb. 21, 2024.

(51) Int. Cl. B29C 64/40; B29C 64/245; B29C 64/264; B29C 64/35; B29C 64/379; B29C 64/386; B29L 31/00; B33Y 10/00; B33Y 30/00; B33Y 40/20; B33Y 80/00

(52) U.S. Cl. CPC B29C 64/40; B29C 64/245; B29C 64/264; B29C 64/35; B29C 64/379; B29C 64/386; B33Y 10/00; B33Y 30/00; B33Y 40/20; B29L 2031/7532; B33Y 80/00

(57) ABSTRACT

Provided according to embodiments of the present invention are methods of additively manufacturing a plurality of parts that include fabricating a loaded base connector grid on a build platform of an additive manufacturing apparatus; removing the loaded base connector grid from the build platform and transferring the loaded base connector grid to a filtration basket set over and/or within a resin recovery bin; removing the filtration basket including the loaded base connector grid from the resin recovery bin; optionally, performing at least one post-processing method on the loaded base connector grid; removing the loaded base connector grid from the filtration basket; and separating the plurality of parts from the base connector grid. Base connector grids and related methods and apparatus are further provided.

### CROSS-REFERENCE TO RELATED APPLICATIONS

This application claims priority from U.S. Provisional Application No. 63/556,208, filed Feb. 21, 2024, the disclosure of which is hereby incorporated by reference in its entirety.

### FIELD

The present invention relates to methods and systems for making polymer parts by an additive manufacturing process. The present invention also relates to support structures for facilitating additive manufacturing processes.

### BACKGROUND

The production of three-dimensional objects from polymerizable resins by stereolithography is known (see, e.g., U.S. Pat. No. 5,236,637 to Hull). Originally, such techniques were considered slow and typically limited to resins that produced brittle or fragile objects suitable only as prototypes. A more recent technique known as continuous liquid interface production (CLIP) allows both more rapid production of objects by stereolithography (see, e.g., U.S. Pat. No. 9,205,601 to DeSimone et al.) and the production of parts with isotropic mechanical properties (see R. Janusziewcz et al., Layerless fabrication with continuous liquid interface production, Proc. Natl. Acad. Sci. USA 113, 11703-11708, Oct. 18, 2016). Along with the introduction of a variety of different dual cure resins for stereolithography (see, e.g., U.S. Pat. No. 9,453,142 to Rolland et al.), these developments make possible the production of a much greater variety of functional and useful objects suitable for real world use.

Accordingly, although advances in additive manufacturing have allowed for production of precision parts at relatively high speeds, there remains a need for new systems that make possible higher volume production of functional parts by additive manufacturing. In particular, there remains a need for processes that streamline the production of large volumes of parts and increase efficiency.

### SUMMARY

Provided according to embodiments of the present invention are methods of additively manufacturing a plurality of parts that include fabricating a loaded base connector grid on a build platform of an additive manufacturing apparatus, wherein the loaded base connector grid comprises a base connector grid and the plurality of parts thereon and/or therein; removing the loaded base connector grid from the build platform and transferring the loaded base connector grid to a filtration basket set over and/or within a resin recovery bin; removing the filtration basket including the loaded base connector grid from the resin recovery bin; optionally, performing at least one post-processing method on the loaded base connector grid; removing the loaded base connector grid from the filtration basket; and separating the plurality of parts from the base connector grid.

Also provided herein are base connector grids (e.g., having additively manufactured parts therein or thereon) according to an embodiment of the present invention.

Further provided according to embodiments of the invention are methods of additively manufacturing a plurality of parts that include fabricating a loaded base connector grid on a build platform of an additive manufacturing apparatus, wherein the loaded base connector grid comprises a base connector grid and the plurality of parts thereon and/or therein; removing the loaded base connector grid from the build platform; optionally, performing at least one post-processing method on the loaded base connector grid; and separating the plurality of parts from the base connector grid.

Also provided in some embodiments of the invention are apparatus for producing a plurality of additively manufactured parts that include an optically transparent member and a build platform, wherein the build platform and the optically transparent member define a build region therebetween; a resin supply operatively associated with a build surface of the optically transparent member and configured to supply resin thereto; a radiation source configured to emit light through the optically transparent member and solidify resin on the build surface and form the plurality of parts (e.g., the final three-dimensional object or an intermediate having the same shape as, or shape to be imparted to, the three-dimensional object); a part removal device configured to remove the plurality of parts from the build platform; a filtration basket that is positioned below the build platform when the part removal device removes the plurality of parts, wherein the filtration basket is optionally positioned above or within a resin recovery bin or system; and a controller operatively associated with the radiation source, part removal device, resin supply, and/or the build platform.

### BRIEF DESCRIPTION OF THE DRAWINGS

FIG. 1A is a digital model of a base connector grid according to an embodiment of the invention.

FIG. 1B is a magnified view of a portion of the base connector grid in FIG. 1A.

FIG. 2 is a cross-sectional view of a border on a base connector grid according to an embodiment of the invention.

FIG. 3 is a digital model of a base connector grid according to an embodiment of the invention having a batch of additively manufactured parts thereon.

FIG. 4 is a digital model of a base connector grid according to an embodiment of the invention having a batch of additively manufactured parts thereon.

FIG. 5A is a digital model of a base connector grid according to an embodiment of the invention having a batch of additively manufactured parts thereon.

FIG. 5B is a digital model of a hinge connection for a base connector grid according to an embodiment of the invention.

FIG. 5C is a digital model of a base connector grid according to an embodiment of the invention that includes at least one hook or fastener thereon.

FIG. 6A is a base connector grid having additively manufactured parts manufactured therein.

FIG. 6B is a magnified view of a portion of the base connector grid and a part in FIG. 6A.

FIG. 7 provides magnified views of portions of a base connector grid according to an embodiment of the invention.

FIG. 8A is an example of a base connector grid having additively manufactured parts therein.

FIG. 8B shows the base connector grid after the additively manufactured parts are removed from the base connector grid.

FIG. 9A is a digital model showing an example of a base connector grid having additively manufactured parts therein.

FIG. 9B is a digital model showing another example of a base connector grid having additively manufactured parts therein.

FIG. 10 is a diagram showing a possible configuration of an apparatus used to perform methods described herein.

FIG. 11 is a picture of a filtration basket set within a resin recovery bin according to certain embodiments of the invention.

FIGS. 12A and 12B are pictures of a filtration basket having loaded base connector grids therein.

FIG. 13A is a picture of an apparatus having a depth camera placed above a filtration basket.

FIG. 13B provides depth camera images of the filtration basket as it is filled with base connector grids.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/of” includes any and all possible combinations or one or more of the associated listed items, as well as the lack of combinations when interpreted in the alternative (“of”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

As used herein, a “plurality” of any element refers to two or more (e.g., 2, 3, 4, 5, 10, 15, 20, 30, 40, 50, or a range defined between any two of the foregoing values) of such elements and may include 10%, 20%, 30%, 40%, 50%, 60%, 70%, 80%, 90%, 95%, 99% or 100%, or any range defined therein, of the total number of elements.

All patents or published patent applications referenced are herein incorporated by reference in their entirety. In the case of conflicting terminology, the present application controls.

### Base Connector Grids and Methods of Using the Same

Provided according to embodiments of the invention are base connector grids that include a plurality of parts thereon and/or therein. Also provided according to embodiments of the invention are methods of additively manufacturing a plurality of parts that includes the steps of (a) additively manufacturing on a build platform a base connector grid that includes the plurality of parts therein and/or thereon; (b) removing the base connector grid (and the plurality of parts therein and/or thereon) from the build platform; (c) optionally performing at least one post-processing step (e.g., washing, drying, and/or further curing) on the base connector grid and plurality of parts thereon and/or therein; and (e) separating the plurality of parts from the base connector grid.

Also provided according to embodiments of the invention are methods of additively manufacturing a plurality of parts that includes the steps of (a) additively manufacturing on a build platform a base connector grid that includes the plurality of parts therein and/or thereon; (b) removing the base connector grid (and the plurality of parts therein and/or thereon) from the build platform and optionally transferring to a filtration basket that is optionally set over and/or within a resin recovery bin; (c) removing the filtration basket including the base connector grid (and the plurality of parts therein and/or thereon) from the resin recovery bin; (d) optionally performing at least one post-processing step (e.g., washing, drying, and/or further curing); (e) removing the base connector grid and the plurality of parts therein and/or thereon from the filtration basket; and (f) separating the plurality of parts from the base connector grid.

### The Base Connector Grid

A base connector grid, as used herein, is an additively manufactured layer that connects parts that are built thereon (set on top of the layer) or therein (set within the layer). As such, the base connector grid is typically configured to extend across all or substantially all of a build platform used during an additive manufacturing process. However, in some embodiments, the base connector grid may be smaller. The base connector grid allows for a batch of additively manufactured parts to remain connected during fabrication and post-processing, which may simplify post-processing and increase efficiency as related parts may remain connected throughout the additive manufacturing process. It is to be understood that while the base connector grids are referred to herein as “grids,” they can be present in many possible configurations including discontinuous or irregular patterns.

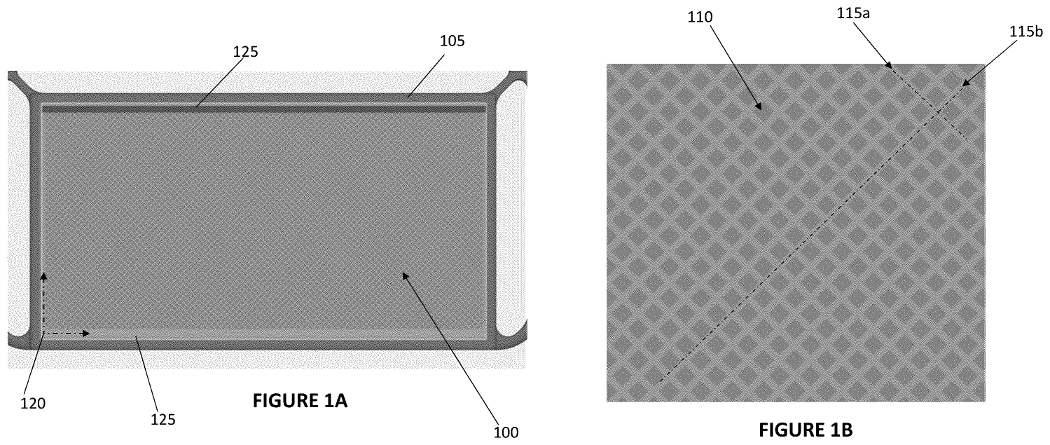

Referring to FIGS. 1A and 1B, in some embodiments, the base connector grid 100 is a simple additively manufactured grid pattern (e.g., a pattern of horizontal and vertical lines that intersect, also referred to herein as a “crosshatch pattern”). FIG. 1A is a digital model showing the base connector grid 100 on a build platform 105, and FIG. 1B is a magnified view of a portion of the base connector grid 100.

The crosshatch pattern of the base connector grid 100 shown in FIGS. 1A and 1B has a particular size but the width of the struts 115a, 115b and the dimensions of the apertures 110 in the base connector grid 100 may vary based on the parts being fabricated. For example, smaller parts may preferably be used with base connector grids 100 having smaller apertures 110. In some embodiments, the strut 115a, 115b width is in a range of from 0.005 mm to 20 mm (e.g., in a range of 0.25 mm to 10 mm, or 0.5 mm, 1.0 mm, 1.5 mm, 2.0 mm, 2.5 mm, 3.0 mm, or a range defined between any two foregoing values). In some embodiments, the aperture 110 width in each dimension is a range of 0.005 mm to 100 mm (e.g., 0.5 mm to 6 mm, or 1.0 mm, 1.5 mm, 2.0 mm, 2.5 mm, 3.0 mm, or a range defined between any two foregoing values).

The orientation and angles of the crosshatch pattern may also vary. In FIGS. 1A and 1B, struts 115a, 115b intersect at an angle of 90 degrees. However, this angle of intersection may vary, such as, for example, between 1 and 90 degrees (e.g., 60 to 90 degrees, including 60, 65, 70, 75, 80, 85, 90 degrees, or a range defined between any two of the foregoing values). In some embodiments, the orientation of the crosshatch pattern of the base connector grid 100 may be rotated relative to the edge of the x-y plane 120 of the base connector grid 100. In some embodiments, the crosshatch pattern is rotated between 0 and 90 degrees (e.g., between 30 to 60 degrees, including 30, 35, 40, 45, 50, 55, 60 degrees, and a range defined between any two of the foregoing values) from the x-y plane 120.

As shown in FIG. 1A, in some embodiments, one or more of the portions (e.g., edges) of the base connector grid 100 includes a border 125 that may facilitate removal of the base connector grid 100 from the build platform 105, may facilitate post-processing methods, and may allow for labeling of the print build. Border 125, in some embodiments, may have a stiffness equal or greater to the stiffness of the portion of the base connector grid 100 having parts thereon, which may facilitate removal of the base connector grid 100. In some embodiments, border 125 includes a solid and/or thickened edge, and may, in some embodiments, include lips, bevels, chamfers, and the like. Border 125 may also be curved, straight, or angular, and may run along one, two, three, or more sides of the base connector grid 100. Further, all of a side or only a portion of a side of the base connector grid 100 may include border 125. The width of border 125 may vary but, in some embodiments, border 125 has a width in a range of 0.025 mm to 100 mm, or in a range of 1 mm to 10 mm, 20 mm, 30 mm, 40 mm, or 50 mm (e.g., 2 mm to 10 mm, or 2 mm, 3 mm, 4 mm, 5 mm, 6 mm, 7, mm 8 mm, or a range defined between any two of the foregoing values).

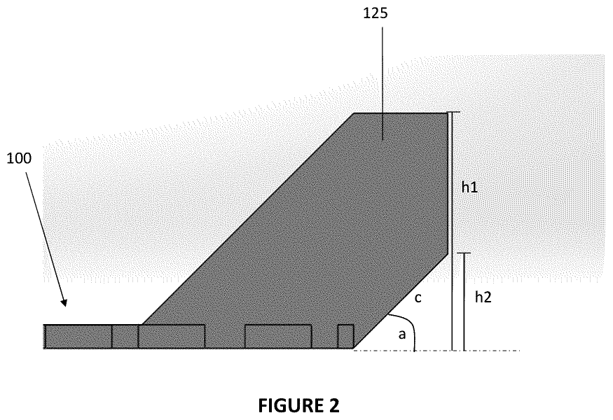

FIG. 2 shows a digital model of a cross-section of one possible border 125 embodiment. In this embodiment, the edge of border 125 is raised or inclined from the build platform at angle a. This may facilitate removal of the base connector grid 100 from the build platform 105 (not shown). In some embodiments, angle a is in a range of 10 degrees to 75 degrees (e.g., 20 to 45 degrees). In some embodiments, border 125 has a height h1 in a range of from 0.025 mm to 100 mm, or in a range of 1 mm to 10 mm, 20 mm, 30 mm, 40 mm, 50 mm (e.g., 2 to 10 mm, or 2 mm, 3 mm, 4 mm, 5 mm, 6 mm, 7, mm 8 mm, or a range defined between any two of the foregoing values). Border 125 may include a chamfered edge c. In some embodiments, the chamfer height h2 is in a range of from 0.025 mm to 100 mm, or in a range of 1 mm to 10 mm, 20 mm, 30 mm, 40 mm, 50 mm (e.g., 2 to 10 mm, or 2 mm, 3 mm, 4 mm, 5 mm, 6 mm, 7, mm 8 mm, or a range defined between any two of the foregoing values).

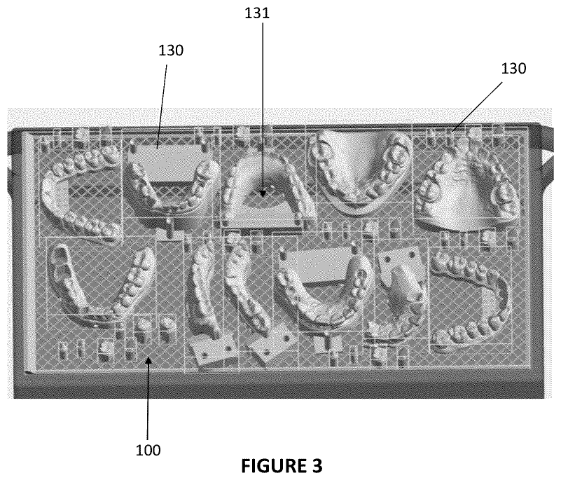

FIG. 3 shows a plurality of additively manufactured parts 130 fabricated within a base connector grid 100, which may also be referred to as a “loaded base connector grid.” The plurality of parts 130 are fabricated so that they are attached/connected to the base connector grid 100 but there is no base connector grid 100 under the parts 130 but only adjacent to and coplanar with parts 130. In the base connector grid 100 shown in FIG. 3, the crosshatch pattern is present around each of the parts 130 but no crosshatch pattern is present under parts 130. In some embodiments, a portion of the base connector grid 100 within the footprint 131 (e.g., the area between the teeth in a dental model) of the part 130 is present (as shown in FIG. 3) and in some embodiments, it is absent or omitted from the grid.

While the base connector grid shown in FIGS. 1A, 1B, and 3 is crosshatched, a wide variety of possible base connector configurations may be used. For example, instead of the square or rectangular apertures shown in FIGS. 1A and 1B, in some embodiments, the base connector grid may be a solid sheet, or the base connector grid may be a solid sheet having a series of circular (or polygonal, or irregular) shaped apertures or holes therein. Such apertures may be regularly or irregularly spaced. In some embodiments, the aperture width is in a range from 0.005 mm to 10 mm, 20 mm, 30 mm, 40 mm, 50 mm, or 100 mm (e.g., 0.5 mm to 6 mm, or 1.0 mm, 1.5 mm, 2.0 mm, 2.5 mm, 3.0 mm, or a range defined between any two foregoing values).

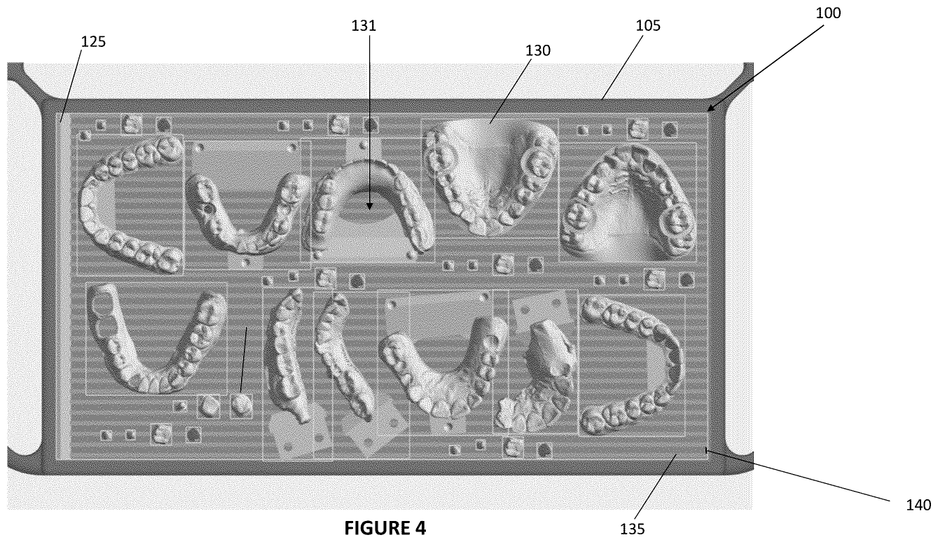

Other possible configurations include but are not limited to those shown in FIGS. 4-9B. In some embodiments, as shown in FIG. 4, the base connector grid 100 may include a series of additively manufactured line segments 135 that span the length of all or a portion of the build platform 105 and connect with the parts 130. The thickness of the line segments 135 and the spacing between line segments 140 may vary depending on the part(s) being formed thereon. In some embodiments, a portion of line segment 135 may be omitted from portions of the base connector grid 100 within the footprint of a part 131 and in portions of the base connector grid 100 without a part 130 manufactured thereon.

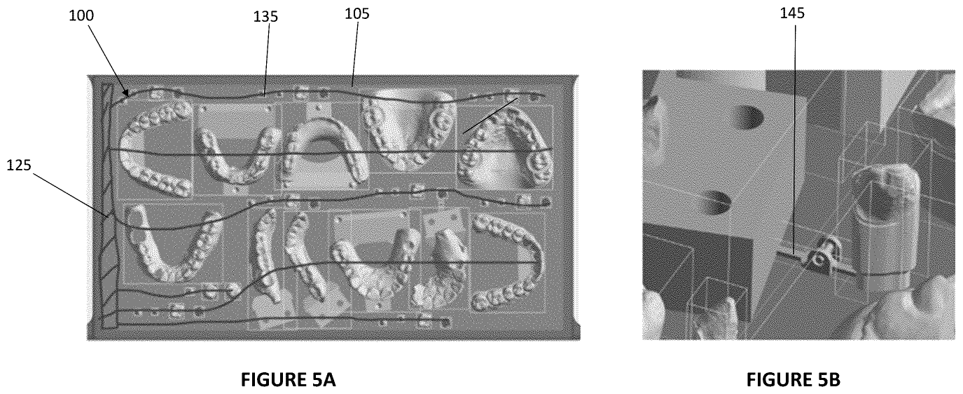

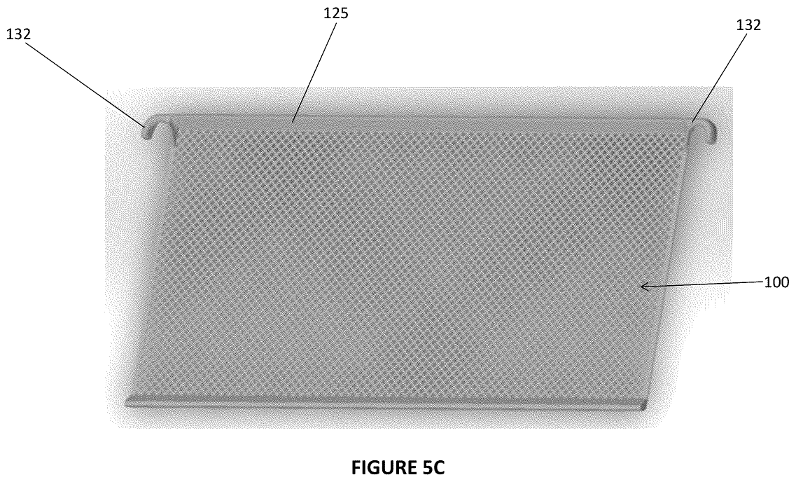

Other possible configurations of the base connector grid 100 are shown in FIGS. 5A and 5B. In FIG. 5A, the base connector grid 100 includes line segments 135 that connect a border 125 to only one or a few attachment points per part 130 (e.g., 1, 2, or 3 points of attachment). While in some embodiments, the line segments are simple additively manufactured solid lines, referring to FIG. 5B, in some cases, the parts 130 may be connected to one another or to border 125 by a detachable mechanism, such as a hinge 145 or ball and socket joint (not shown). In some embodiments, the base connector grid 100 is bendable or flexible in the x, y, and/or z directions. For example, the base connector grid 100 may be formed of interconnecting links (e.g., chainmail links) so that the base connector grid 100 is flexible and may more easily stack (e.g., in the filtration basket). Other geometric structures and connections that allow for flexibility of the base connector grid 100 may also be used. In some embodiments, the line segments 135 and/or crosshatch patterns of the base connector grid 100 may be curved, discontinuous, and/or form irregular patterns. A wide variety of configurations are possible provided that the plurality of parts 130 are connected as they are removed from the build platform.

In particular embodiments, the base connector grid 100 (including border 125) may include additional features that may facilitate post-processing methods. For example, referring to FIG. 5C, in some embodiments, the base connector grid 100 (including border 125) includes at least one hook 132, groove, aperture (of any shape), or other fastener that attaches the base connector grid 100 to a post-processing apparatus (e.g., to a rack for drying, to a washing apparatus or bin, and/or to a spinning apparatus).

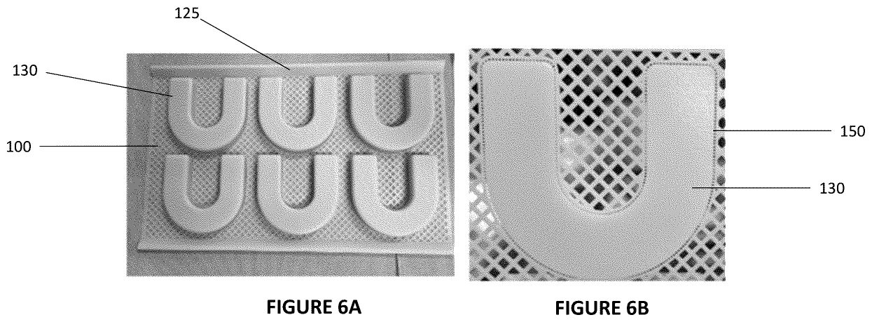

Referring to FIGS. 6A and 6B, in some embodiments, the region of the base connector grid 100 that is directly adjacent (bordering) the parts 130 has a different size or shape than the rest of the base connector grid 100 to facilitate removal of the part 130 from the base connector grid 100. In some embodiments, a perforated border 150 connects part 130 and base connector grid 100. After removal from the build platform and any post-processing steps, each part 130 may be removed from the base connector grid 100 by breaking the perforated border 150, akin to breaking the perforations around a postage stamp.

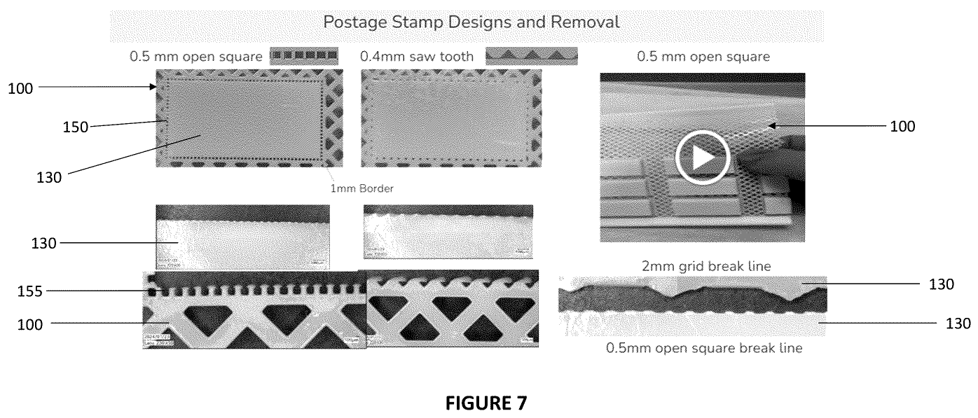

The size, shape, and orientation of the apertures or struts in such base connector grids 100 may vary as described, for example, with respect to FIGS. 1-5. The size, shape, and orientation of the perforated border 150 may also vary according to the particular part(s) being fabricated. For example, as shown in FIG. 7, in some embodiments, the perforations 155 in the perforated border 150 are square or sawtooth shaped. Other perforation 155 shapes may be used, including circular, polygonal, or irregularly shaped. The perforated border 150 may also have any suitable width. For example, in some embodiments, the perforated border 150 has a width in a range of 0.005 mm to 20 mm, such 0.25 mm, 0.50 mm, 1.0 mm, 1.5 mm, 2.0 mm, 2.5 mm, 3.0 mm, or a range defined between any two foregoing values. The thickness (in the z direction) of the perforated border 150 may also vary. For example, in some embodiments, the thickness of the perforated border 150 is in a range from 0.005 mm to 10 mm, such as 0.25 mm to 2 mm, or 0.10 mm, 0.20 mm, 0.30 mm, 0.40 mm, 0.50 mm, 0.60 mm, 0.70 mm 0.80 mm, 0.90 mm, 1.0 mm, or a range defined between any two of the foregoing values. In some embodiments, the perforations 155 in the perforated border 150 have a diameter (or longest width) in a range of 0.005 mm to 5 mm, such as 0.25 mm to 2 mm, or 0.10 mm, 0.20 mm, 0.30 mm, 0.40 mm, 0.50 mm, 0.60 mm, 0.70 mm 0.80 mm, 0.90 mm, 1.0 mm, or a range defined between any two of the foregoing values. In some embodiments, spacing between perforations 155 in the perforated border 150 are in a range of 0.005 mm to 5 mm, such as 0.1 mm to 1 mm, or 0.10 mm, 0.15 mm, 0.20 mm, 0.25 mm, 0.30 mm, 0.40 mm, 0.50 mm, or a range defined between any two of the foregoing values.

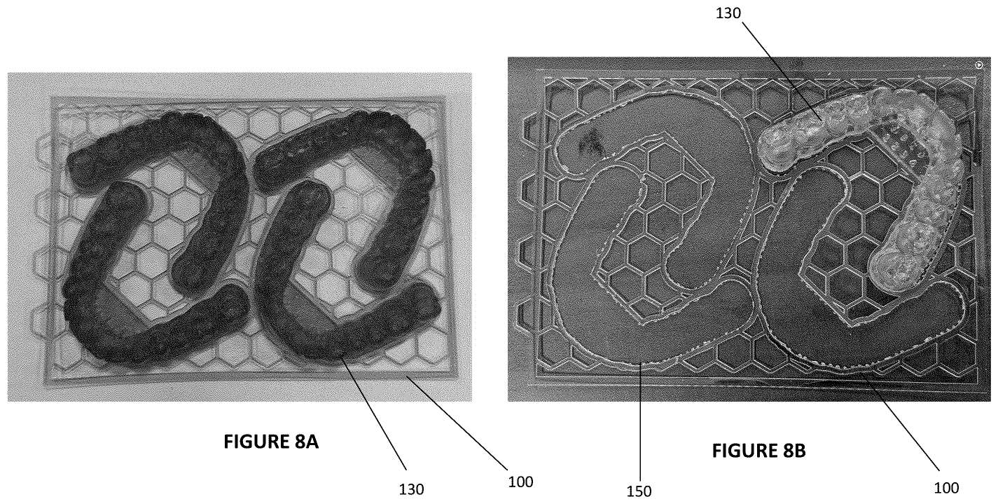

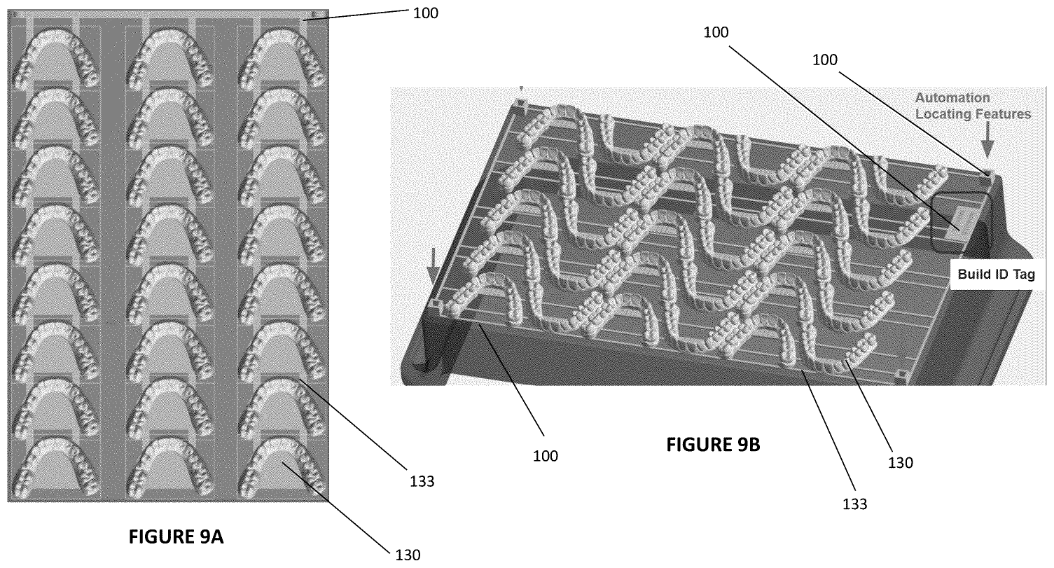

Other examples are shown in FIGS. 8A, 8B, 9A, and 9B. FIG. 8A shows a base connector grid 100 having a hexagonal pattern and parts 130 formed therein. In some cases, a pattern such a hexagonal (or other polygonal shape) pattern may facilitate removal by reducing the number of contact points a plow or peeling device encounters at one time point during removal of the base connector grid 100 from the build platform (not shown). FIG. 8B shows the base connector grid in FIG. 8A after the removal from the additive manufactured parts 130 therefrom. It can be seen that the parts 130 have a perforated border 150 around the parts 130 that facilitates removal.

FIGS. 9A and 9B provide examples of base connector grids 100 that may facilitate the automation of the removal of the additively manufactured parts 130 from the base connector grid. FIGS. 9A and 9B show base connector grids 100 having linear arrays of parts that are connected to one another. The uniform location of connection points 133 connecting the parts 130 and/or the minimal number of connection points 133 between parts 130 (e.g., 1, 2, 3, 4, or 5) may facilitate the automation of part removal or separation from the base connector grid 100 and/or other parts 130. FIG. 9B illustrates that, in some embodiments, the base connector grid 100 may include apertures 132 or other features that can be used for an automated device (not shown) to connect or orient the base connector grid 100 for automated part removal and/or for other post-processing steps.

The thickness of the base connector grid 100 may vary due to the parts 130 being printed thereon, the resin used, etc. However, in some embodiments, the thickness of the base connector grid 100 is in a range of 0.005 mm or 0.25 mm to 10 mm, 20 mm, 30 mm, 40 mm or 50 mm (e.g., 0.25 mm to 2 mm, or 0.10 mm, 0.20 mm, 0.30 mm, 0.40 mm, 0.50 mm, 0.60 mm, 0.70 mm 0.80 mm, 0.90 mm, 1.0 mm, or a range defined between any two of the foregoing values).

### Additive Manufacturing Methods, Apparatus, and Resins

Base connector grids and parts (e.g., dental appliances), as described above, may be fabricated by many possible additive manufacturing processes. Suitable techniques include, but are not limited to, techniques such as selective laser sintering (SLS), fused deposition modeling (FDM), stereolithography (SLA), material jetting including three-dimensional printing (3DP) and multijet modeling (MJM) (MJM including Multi-Jet Fusion such as available from Hewlett Packard), and others. See, e.g., H. Bikas et al., Additive manufacturing methods and modelling approaches: a critical review, Int. J. Adv. Manuf Technol. 83, 389-405 (2016).

Stereolithography, including bottom-up and top-down techniques, are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. Such techniques may be used herein.

Resins for additive manufacturing of polymer articles are known and described in, for example, DeSimone et al., U.S. Pat. Nos. 9,211,678; 9,205,601; and 9,216,546. Dual cure resins for additive manufacturing are known and described in, for example, Rolland et al., U.S. Pat. Nos. 9,676,963; 9,598,606; and 9,453,142. Non-limiting examples of dual cure resins include, but are not limited to, resins for producing objects comprised of polymers such as polyurethane, polyurea, and copolymers thereof; objects comprised of epoxy; objects comprised of cyanate ester; objects comprised of silicone, etc. Any suitable resin may be used to form the parts or base connector grids of the invention, including single cure, dual cure, elastomer-forming resins, and thermoset-forming resins.

In some embodiments, the object is formed by continuous liquid interface production (CLIP). CLIP is known and described in, for example, PCT Application Nos. PCT/US2014/015486 (U.S. Pat. No. 9,211,678); PCT/US2014/015506 (U.S. Pat. No. 9,205,601), PCT/US2014/015497 (U.S. Pat. No. 9,216,546), and in J. Tumbleston, D. Shirvanyants, N. Ermoshkin et al., Continuous liquid interface production of 3D Objects, Science 347, 1349-1352 (2015). See also R. Janusziewcz et al., Layerless fabrication with continuous liquid interface production, Proc. Natl. Acad. Sci. USA 113, 11703-11708 (Oct. 18, 2016). In some embodiments, CLIP employs features of a bottom-up three-dimensional fabrication as described above, but the irradiating and/or the advancing steps are carried out while also concurrently maintaining a stable or persistent liquid interface between the growing object and the build surface or window, such as by: (i) continuously maintaining a dead zone of polymerizable liquid in contact with the build surface, and (ii) continuously maintaining a gradient of polymerization zone (such as an active surface) between the dead zone and the solid polymer and in contact with each thereof, the gradient of polymerization zone comprising the first component in partially-cured form. In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. Other approaches for carrying out CLIP that can be used in the present invention and obviate the need for a semipermeable “window” or window structure include utilizing a liquid interface comprising an immiscible liquid (see L. Robeson et al., WO 2015/164234, published Oct. 29, 2015), generating oxygen as an inhibitor by electrolysis (see I. Craven et al., WO 2016/133759, published Aug. 25, 2016), and incorporating magnetically positionable particles to which the photoactivator is coupled into the polymerizable liquid (see J. Rolland, WO 2016/145182, published Sep. 15, 2016).

Other examples of methods and apparatus for carrying out particular embodiments of CLIP include, but are not limited to: Batchelder et al., Continuous liquid interface production system with viscosity pump, US Patent Application Pub. No. US 2017/0129169 (May 11, 2017); Sun and Lichkus, Three-dimensional fabricating system for rapidly producing objects, US Patent Application Pub. No. US 2016/0288376 (Oct. 6, 2016); Willis et al., 3d print adhesion reduction during cure process, US Patent Application Pub. No. US 2015/0360419 (Dec. 17, 2015); Lin et al., Intelligent 3d printing through optimization of 3d print parameters, US Patent Application Pub. No. US 2015/0331402 (Nov. 19, 2015); and D. Castanon, Stereolithography System, US Patent Application Pub. No. US 2017/0129167 (May 11, 2017).

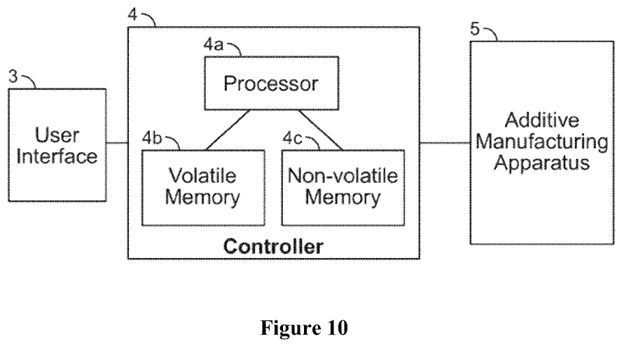

In some embodiments, the part and/or base connector grid is formed using a method or apparatus schematically illustrated in FIG. 10. Such an apparatus includes a user interface 3 for inputting instructions (such as selection of an object to be produced, and selection of features to be added to the object), a controller 4, and an additive manufacturing apparatus 5 such as described above. An optional washer (not shown) can be included in the system if desired, or a separate washer can be utilized. Similarly, for dual cure resins, an oven (not shown) can be included in the system, although a separately operated oven can also be utilized.

Connections between components of the system can be by any suitable configuration, including wired and/or wireless connections. The components may also communicate over one or more networks, including any conventional, public and/or private, real and/or virtual, wired and/or wireless network.

Controller 4 may be of any suitable type, such as a general-purpose computer. Typically, the controller 4 will include at least one processor 4a, a volatile (or “working”) memory 4b, such as random-access memory, and at least one non-volatile or persistent memory 4c, such as a hard drive or a flash drive. The controller 4 may use hardware, software implemented with hardware, firmware, tangible computer-readable storage media having instructions stored thereon, and/or a combination thereof, and may be implemented in one or more computer systems or other processing systems. The controller 4 may also utilize a virtual instance of a computer. As such, the devices and methods described herein may be embodied in any combination of hardware and software that may all generally be referred to herein as a “circuit,” “module,” “component,” and/or “system.” Furthermore, aspects of the present invention may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one processor 4a of the controller 4 may be configured to execute computer program code for carrying out operations for aspects of the present invention, which computer program code may be written in any combination of one or more programming languages, including an object oriented programming language such as Java, Scala, Smalltalk, Eiffel, JADE, Emerald, C++, C#, VB.NET, or the like, conventional procedural programming languages, such as the “C” programming language, Visual Basic, Fortran 2003, COBOL 2002, PHP, ABAP, dynamic programming languages such as Python, PERL, Ruby, and Groovy, or other programming languages.

The at least one processor 4a may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices, which may be collocated or distributed across one or more data networks.

Connections between internal components of the controller 4 are shown only in part and connections between internal components of the controller 4 and external components are not shown for clarity, but are provided by additional components known in the art, such as busses, input/output boards, communication adapters, network adapters, etc. The connections between the internal components of the controller 4, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, an Advanced Technology Attachment (ATA) bus, a Serial ATA (SATA) bus, and/or an Institute of Electrical and Electronics Engineers (IEEE) standard 1394 bus, also called “Firewire.”

The user interface 3 may be of any suitable type. The user interface 3 may include a display and/or one or more user input devices. The display may be accessible to the at least one processor 4a a via the connections between the system components. The display may provide graphical user interfaces for receiving input, displaying intermediate operation/data, and/or exporting output of the methods described herein. The display may include, but is not limited to, a monitor, a touch screen device, etc., including combinations thereof. The input device may include, but is not limited to, a mouse, keyboard, camera, etc., including combinations thereof. The input device may be accessible to the at least one processor 4a via the connections between the system components. The user interface 3 may interface with and/or be operated by computer readable software code instructions resident in the volatile memory 4b that are executed by the processor 4a.

In some embodiments, the method further include the steps of (prior to additive manufacturing), (i) providing digital model(s) of the plurality of parts; (ii) determining a desired configuration of the plurality of parts on the build platform (e.g., a configuration determined by a computer processor as providing an optimal orientation based on factors including maximum parts per build, minimal resin use, and the like); (iii) creating a digital model of the base connector grid and the plurality of parts in the desired configuration; (iv) processing the digital model in step (iii) to form processed data for use by the additive manufacturing apparatus; and transmitting the processed data to the additive manufacturing apparatus.

Any parts may be fabricated according to embodiments of the invention. However, in some embodiments, the plurality of parts are dental appliances. Dental appliances include but are not limited to prosthetic denture bases, partial dentures, and teeth (e.g., inlays, onlays, veneers, long term provisionals, etc.). In some embodiments, the batch of parts includes dental appliances associated with a single patient.

Removal of Base Connector Grid from Build Platform

Once a plurality of parts is additively manufactured on and/or within the base connector grid (hereinafter, referred to as a “loaded base connector grid”), they may be removed from the build platform by any suitable method. For example, the loaded base connector grid may be manually peeled, plowed, cut, or otherwise removed from the build platform. In other embodiments, the loaded base connector grid may be removed from the build platform by an automated or robotic mechanism (also referred to as a “part removal device”) that, for example, peels, plows, or cuts the loaded base connector grid off the build platform. In some embodiments, once the loaded base connector grid is removed from the build platform, it is transferred to a filtration basket (e.g., a filtration basket set over a resin recovery bin). As used herein, “transferring” the loaded base connector grid includes manually transferring, transferring via an automated or robotic mechanism, or simply allowing the loaded base connector grid to fall into the filtration basket. In some embodiments, it is transferred directly to a wash basket, a washer, or other post-processing apparatus.

In particular embodiments, a part removal device removes (e.g., peels, plows, or cuts) the loaded base connector grid from the build platform such that it drops into or is pushed into a basket or bin. In some embodiments, the loaded base connector grid is dropped into a filtration basket and/or a resin recovery bin (and the filtration basket may be set on and/or within the resin recovery basket). In some embodiments, the filtration basket and/or resin recovery bin are positioned below the build platform during removal of the base connector grid, which falls into the filtration basket once removed. In some embodiments, the a part removal device is a plow or peeler that moves continuously across the surface of the build platform to remove the loaded base connector. In other embodiments, the part removal device is a plow or peeler that moves in a discontinuous fashion, for example, in a reciprocating or back-and-forth (or “jackhammer”) motion. Such a motion may facilitate removal of the loaded base connector from the build platform.

The filtration basket may be any container that can hold a base connector grid of the invention and allows for excess resin to pass therethrough and into the resin recovery bin (or other resin recovery or removal apparatus or system). As such, the filtration basket includes but is not limited to a polymer or metal mesh basket, a polymer or metal bin having a plurality of apertures therein, and the like. In some embodiments, the filtration basket is sufficiently large to hold up to 5 to 30 (e.g., 10 to 25) base connector grids. The resin recovery bin may be set below and/or around the filtration basket and can be any container that will retain the resin that passes through the filtration basket. In some embodiments, the resin recovery bin may include a reservoir and/or connection that allows resin to flow to another resin recovery apparatus (e.g., for filtration, mixing with other resin, etc.) but in some embodiments, a simple bin (e.g., polymer or metal) may be used.

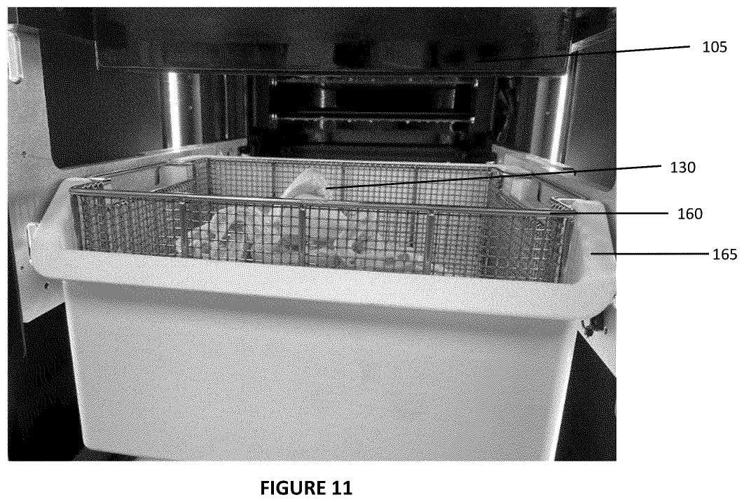

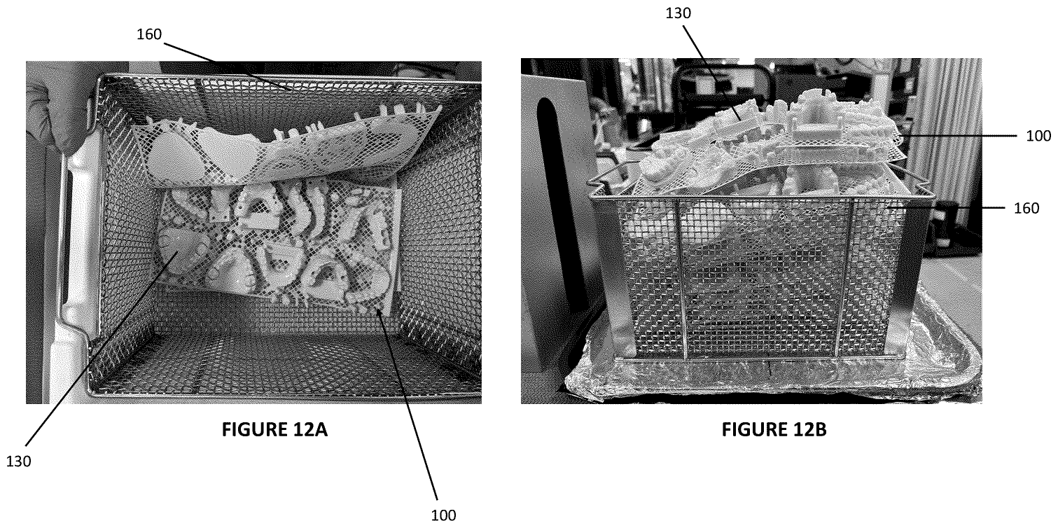

FIG. 11 shows a filtration basket 160 and resin recovery bin 165 set under a build platform 105. In FIG. 11, the parts 130 in filtration basket 160 are not in or on a base connector grid, but FIGS. 12A and 12B show multiple base connector grids 100 within a filtration basket 160. While the filtration basket 160 and resin recovery bin 165 may be used in combination, as described above, in some embodiments, only a filtration basket is used, and in some embodiments, only a resin recovery bin is used. In some embodiments, neither the filtration basket nor the resin recovery bin is used (e.g., if the base connector grids are transferred directly to a washer or other post-processing apparatus).

In some embodiments of the invention, an additive manufacturing apparatus or system fabricates a loaded base connector grid 100; the loaded base connector grid 100 is removed from the build platform 105 and transferred to the filtration basket 160. This process is repeated multiple times until the filtration basket 160 includes a plurality (e.g., 2 to 20 or 30) base connector grids 100. While subsequent base connector grids 100 are fabricated, excess resin from the previous builds may be drained through the filtration basket 160 (and optionally into the resin recovery bin 165). If removal of the loaded base connector grid 100 from the build platform 105 is automated, multiple batches of parts 130 may be fabricated on the apparatus and transferred to the filtration basket without the need for manual intervention.

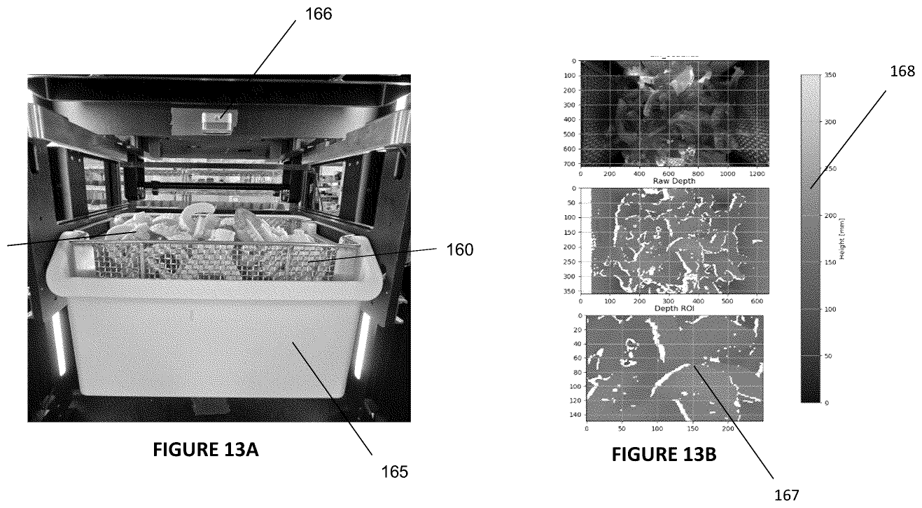

Referring to FIGS. 13A and 13B, in some embodiments of the invention, the additive manufacturing apparatus (or other removal apparatus) may include a depth sensing camera 166 (e.g., located above the filtration basket 160) that can identify the level of base connector grids 100 in the filtration basket 160. In some embodiments, the depth camera also includes RGB/color capabilities to facilitate monitoring of the number of base connector grids 100 in the filtration basket 160 and/or resin recovery bin 165. FIG. 13B shows how a depth sensing camera may image 167 the base connector grids 100 and monitor the level, e.g., by correlating a color range 168 with a certain loading depth, of base connector grids 100 in the filtration basket 160 and/or resin recovery bin 165.

### Post-Processing of Parts

In some embodiments of the invention, the plurality of parts and/or the loaded base connector grid may be washed while in the filtration basket. For example, the filtration basket may be removed from the resin recovery bin and placed into a bin or other container filled with washing fluid (e.g., isopropyl alcohol) and optionally agitated to facilitate removal of excess resin from the parts. Submersion of the basket into additional washing fluids (including fresh portions of the same washing fluid) may also be performed in some embodiments.

Additionally or alternatively, the plurality of parts may be dried (e.g., via centrifugal separation, wiping, and/or blowing) and/or further cured while in and/or on the base connector grid (and optionally while in the filtration basket). In some embodiments, once the optional washing step is performed, the base connector grids may be removed from the filtration basket for drying and/or further curing, such by baking or contacting to water, see, e.g., U.S. Pat. No. 9,453,142. In some embodiments, once the loaded base connector grid is fully washed, dried, and/or cured, the plurality of parts may be removed (detached, cut, clipped, etc.) from the base connector grid (either manually or via an automated process). However, in some embodiments, the parts may be removed from the base connector grid prior to washing, drying, and/or curing.

The methods of the invention may be advantageous as a plurality of parts (e.g., batch of related parts) may be fabricated and post-processed together, which may simplify assembly of kits (e.g., dental appliances for the same patient) and increase efficiency. In addition, the use of the base connector grid in combination with the filtration basket may allow for multiple print batches to be fabricated without human intervention and may simplify the sorting and processing of such multiple batches.

### Apparatus

In some embodiments of the invention, also provided are additive manufacturing apparatus that are configured to perform a method described herein. For example, in some embodiments of the invention, provided are apparatus that are configured to produce a loaded base connector grid (e.g., via an additive manufacturing process such as stereolithography); remove the loaded base connector grid from the build platform (e.g., via a method described herein) and transfer the loaded base connector grid to a filtration basket. The apparatus or system may be further configured to repeat this process of fabrication and removal of base connector grids multiple times until the filtration basket includes a plurality (e.g., 2 to 20 or 30) of base connector grids. In some embodiments, the removal of the loaded base connector grid from the build platform is automated and multiple batches of parts may be fabricated on the apparatus and transferred to the filtration basket without the need for manual intervention. The apparatus may further include a controller, as described above, to facilitate, operate, and/or automate any of the apparatus operations.

In particular embodiments of the invention, apparatus include an optically transparent member and a build platform, wherein the build platform and the optically transparent member define a build region therebetween; a resin supply operatively associated with a build surface of the optically transparent member and configured to supply resin thereto; a radiation source configured to emit light through the optically transparent member and solidify resin on the build surface and form the plurality of parts (e.g., the final three-dimensional object or an intermediate having the same shape as, or shape to be imparted to, the three-dimensional object); a part removal device configured to remove the plurality of parts from the build platform; a filtration basket that is positioned below the build platform when the object removal device removes the plurality of parts, wherein the filtration basket is optionally positioned above or within a resin recovery bin or system; and a controller operatively associated with the radiation source, part removal device, resin supply, and/or the build platform. In some embodiments, the part removal device is configured to remove a base connector grid comprising the plurality of three-dimensional objects. The plurality of parts are still considered a plurality of parts even when connected via the base connector grid.

The apparatus may include a controller that directs the apparatus to (1) produce a first plurality of parts on the build platform, remove the first plurality of parts from the build platform using the part removal device, and transfer the first plurality of parts (e.g., via gravity) to the filtration basket; (2) produce an additional plurality of parts on the build platform, remove the additional plurality of parts from the build platform using the part removal device, and transfer the additional plurality of parts (e.g., via gravity) to the filtration basket; and (3) optionally, repeat step (2) until the additively manufactured parts (and/or base connector grids) in the filtration basket reach a predefined level and/or a predefined number of three-dimensional objects are produced. The predefined level may be determined, for example, by a depth camera, or by knowledge of the size and shapes of the objects and/or base connector grid.

Accordingly an additive manufacturing device, including those described herein, may be an apparatus of the invention. However, in some embodiments, an auxiliary apparatus is attached, connected to, and/or combined with an additive manufacturing apparatus to perform the removal of the base connector grid and/or facilitate collection of the base connector grids, for example, in a filtration basket and/or resin recovery bin or system. Accordingly, the term apparatus is intended to refer to both an additive manufacturing apparatus and those systems that may be attached, connected to, and/or combined with the additive manufacturing apparatus to perform methods described herein.

The foregoing is illustrative of the present invention and is not to be construed as limiting thereof. The invention is defined by the following claims, with equivalents of the claims to be included therein.

We claim:

1. A method of additively manufacturing a plurality of parts comprising:
(a) fabricating a loaded base connector grid on a build platform of an additive manufacturing apparatus, wherein the loaded base connector grid comprises a base connector grid and the plurality of parts thereon and/or therein;
(b) removing the loaded base connector grid from the build platform and transferring the loaded base connector grid to a filtration basket set over and/or within a resin recovery bin;
(c) removing the filtration basket including the loaded base connector grid from the resin recovery bin;
(d) optionally, performing at least one post-processing method on the loaded base connector grid;
(e) removing the loaded base connector grid from the filtration basket; and
(f) separating the plurality of parts from the base connector grid.

2. The method of claim 1, wherein the plurality of parts includes dental appliances (e.g., dental appliances for a single patient).

3. The method of claim 1, wherein the steps (a) and (b) are repeated (e.g., 10 to 20 times) such that multiple loaded base connector grids are transferred to the filtration basket before step (c) is performed.

4. The method of claim 1, wherein the plurality of parts are additively manufactured on the base connector grid.

5. The method of claim 1, wherein the parts are additively manufactured such that they are set within a portion of the base connector grid.

6. The method of claim 5, wherein the loaded base connector grid includes a perforated border around each of the plurality of parts.

7. The method of claim 1, wherein the base connector grid comprises a border, optionally wherein the border includes a beveled, raised, or chamfered edge.

8. The method of claim 1, wherein the base connector grid comprises a crosshatch pattern, optionally wherein the crosshatch pattern is rotated (e.g., rotated 20-60 degrees) relative to edge of the x-y plane of the base connector grid.

9. The method of claim 1, wherein the base connector grid comprises one or more additively manufactured line segments connecting the plurality of parts, optionally wherein the one or more line segments further connect the plurality of parts to at least one border.

10. The method of claim 1, further comprising, prior to step (a):
(i) providing digital model(s) of the plurality of parts;
(ii) determining a configuration of the plurality of parts on the build platform (e.g., via an optimization algorithm);
(iii) creating a digital model of the base connector grid (e.g., a digital model that is modified based on the determined configuration of the plurality of parts on the build platform)
(iv) processing the digital model(s) of the plurality of parts and the digital model of the base connector grid to form processed data for use by the additive manufacturing apparatus; and
(v) transmitting the processed data to the additive manufacturing apparatus.

11. The method of claim 10, wherein a computer processor determines the configuration of the plurality of parts using an optimization algorithm and/or creates the digital model of the base connector grid that is modified based on the determined configuration of the plurality of parts on the build platform.

12. The method of claim 10, wherein the base connector grid includes a border (optionally wherein the border includes identifying information regarding the plurality of parts).

13. The method of claim 1, wherein the loaded base connector grid is washed while in the filtration basket.

14. The method of claim 1, wherein excess resin from the loaded base connector grid drains therefrom while in the filtration basket and passes through the filtration basket and into the resin recovery bin (optionally wherein the excess resin is re-used in a subsequent additive manufacturing process).

15. A method of additively manufacturing a plurality of parts comprising:
(a) fabricating a loaded base connector grid on a build platform of an additive manufacturing apparatus, wherein the loaded base connector grid comprises a base connector grid and the plurality of parts thereon and/or therein;
(b) removing the loaded base connector grid from the build platform;
(c) optionally, performing at least one post-processing method on the loaded base connector grid; and
(d) separating the plurality of parts from the base connector grid.

16. The method of claim 15, wherein the plurality of parts includes dental appliances (e.g., dental appliances for a single patient).

17. The method of claim 15, wherein the plurality of parts are additively manufactured on the base connector grid.

18. The method of claim 15, wherein the plurality of parts are additively manufactured within a portion of the base connector grid.

19. The method of claim 18, wherein the loaded base connector grid includes a perforated border around each of the plurality of parts.

20. The method of claim 15, wherein the base connector grid comprises a border, optionally wherein the border includes a beveled, raised, or chamfered edge.

21. The method of claim 15, wherein the base connector grid comprises a crosshatch pattern, optionally wherein the crosshatch pattern is rotated (e.g., rotated 20-60 degrees) relative to edge of the x-y plane of the base connector grid.

22. The method of claim 15, wherein the base connector grid comprises one or more additively manufactured line segments connecting the plurality of parts, optionally wherein the one or more line segments further connect the plurality of parts to at least one border.

23. The method of claim 15, further comprising, prior to step (a):
(i) providing digital model(s) of the plurality of parts;
(ii) determining a configuration of the plurality of parts on the build platform (e.g., via an optimization algorithm);
(iii) creating a digital model of the base connector grid (e.g., a digital model that is modified based on the determined configuration of the plurality of parts on the build platform);
(iv) processing the digital model(s) of the plurality of parts and the digital model of the base connector grid to form processed data for use by the additive manufacturing apparatus; and
(v) transmitting the processed data to the additive manufacturing apparatus.

24. The method of claim 23, wherein a computer processor determines the configuration of the plurality of parts using an optimization algorithm and/or creates the digital model of the base connector grid that is modified based on the determined configuration of the plurality of parts on the build platform.

25. The method of claim 15, wherein the loaded base connector grid is washed and/or undergoes other post-processing steps after removal from the build platform.

26. An apparatus for producing a plurality of additively manufactured parts, the apparatus comprising:
(a) an optically transparent member and a build platform, wherein the build platform and the optically transparent member define a build region therebetween;
(b) a resin supply operatively associated with a build surface of the optically transparent member and configured to supply resin thereto;
(c) a radiation source configured to emit light through the optically transparent member and solidify resin on the build surface and form the plurality of parts (e.g., the final three-dimensional object or an intermediate having the same shape as, or shape to be imparted to, the three-dimensional object);
(d) a part removal device configured to remove the plurality of parts from the build platform;
(e) a filtration basket that is positioned below the build platform when the part removal device removes the plurality of parts, wherein the filtration basket is optionally positioned above or within a resin recovery bin or system; and
(f) a controller operatively associated with the radiation source, part removal device, resin supply, and/or the build platform.

27. The apparatus of claim 26, wherein the part removal device is configured to remove a base connector grid comprising the plurality of parts.

28. The apparatus of claim 26, wherein the controller directs the apparatus to (1) produce a first plurality of parts on the build platform, remove the first plurality of parts from the build platform using the part removal device, and transfer the first plurality of parts (e.g., via gravity) to the filtration basket;
(2) produce an additional plurality of parts on the build platform, remove the additional plurality of parts from the build platform using the part removal device, and transfer the additional plurality of parts (e.g., via gravity) to the filtration basket; and
(3) optionally, repeat step (2) until the parts in the filtration basket reach a predefined level and/or a predefined number of parts are produced.
